(19) United States
(12) Patent Application Publication
(10) Pub. No.: US 2001/0036821 A1
(43) Pub. Date: Nov. 1, 2001

(54) COMPUTER-BASED METHOD AND APPARATUS FOR CONTROLLING, MONITORING, RECORDING AND REPORTING WIRELESS COMMUNICATIONS

(76) Inventors: JAY L. GAINSBORO, FRAMINGHAM, MA (US); CHUCK MARGOSIAN, FRAMINGHAM, MA (US)

Correspondence Address: WARD AND OLIVO, 708 THIRD AVENUE, NEW YORK, NY, 10017

(21) Appl. No.: 09/131,348

(22) Filed: Aug. 10, 1998

Related U.S. Application Data
(63) Continuation-in-part of application No. 08/904,784, filed on Aug. 1, 1997.
Application No. 08/904,784 is a continuation of application No. 08/510,327, filed on Aug. 2, 1995, now Pat. No. 5,655,013.
Application No. 08/510,327 is a continuation of application No. 08/229,517, filed on Apr. 19, 1994, now abandoned.

(51) Int. Cl. H04Q 7/20

(52) U.S. Cl. 455/410; 455/411; 455/435; 455/456

(57) ABSTRACT

The present invention relates to a microprocessor-based method and apparatus for controlling wireless communications (via cellular radiotelephone or some other known means) into or out of a controlled, institutional environment, such as a prison, military base, hospital, school, business or government organization. With the reduced size, cell phones can be smuggled into prison facilities, or be otherwise made available to inmates, to communicate information with individuals outside the facility. Inmates may thus bypass the normal land line telephone control system commonly used to control communication into and out of a prison, such as described in Gainsboro U.S. Pat. No. 5,655,013. Accordingly, a radiotelephone interface is provided, with apparatus for detecting and controlling wireless transmissions either by a caller from within the institution or by a caller from outside the institution. The identification of an unauthorized wireless transmission is accomplished through the detection of certain identifying signals, i.e. NPA/NXX/ESN, which are commonly associated with such transmissions, or, alternatively, via voice recognition. The method and apparatus herein are for managing institutional telephone activity, and utilize a wireless communication scanner/receiver, a microprocessor-based control unit, and optional transmitter. The system monitors wireless transmissions, tests signals for approval, and enables or prevents the transmissions via jamming or other means. An alternate embodiment comprises the integration of cellular radiotelephone base station equipment into the prison facility.

### CROSS-REFERENCE TO RELATED APPLICATIONS

This application is filed as a continuation-in-part of application Ser. No. 08/904,784, filed Aug. 1, 1997, which is a continuation of application Ser. No. 08/510,327, filed Aug. 2, 1995 (now U.S. Pat. No. 5,655,013), which is a continuation of application Ser. No. 08/229,517, filed Apr. 19, 1994, now abandoned.

### TECHNICAL FIELD OF THE INVENTION

The present invention relates generally to the fields of telecommunications and penal institution management. More particularly, the invention relates to a computer-based method and apparatus for intercepting, controlling, monitoring, recording and reporting wireless communications in a controlled, institutional environment, such as a prison, military base, hospital, school, business or government organization. Specifically, this invention relates to an apparatus and method for the detection, interception, and/or control of wireless radiotelephone communications initiated either from within the institution to some location outside the institution or from outside the institution to an individual within the institution. In one preferred method and apparatus, detection is accomplished through the use of at least one (usually several) reception antennae, selectively positioned around the institution, which detect any wireless transmission and transmit the captured signals (NPA/NXX/ESN, MIN, voice, or other relevant data) to a call control system for processing, monitoring, and/or recording. Alternatively, the interception, control, and monitoring may be accomplished via the installation of a cellular radiotelephone system base station, provided by the penal institution, which may be integrated into the local cellular network.

### BACKGROUND OF THE INVENTION

Generally, the need to control access to outside telephone lines in an institutional environment is well recognized. In order to prevent individuals from incurring large, unaccountable telephone costs which the institution ultimately bears, one must either restrict access to outside telephone lines or institute accounting controls whereby the costs of unauthorized calls can be billed to the responsible individuals.

Telephone systems in correctional environments require additional security considerations. Without appropriate controls on telephone access, inmates have been known to use the telephones to harass outside parties (such as witnesses who testified against them, attorneys who prosecuted their case, employees of the courts, etc.), to perpetrate fraudulent schemes, and to participate in criminal conspiracies (such as arranging the smuggling of contraband into the prison, directing an outside criminal enterprise, plotting escape attempts or credit card fraud). Therefore, it is critically important for correctional management officials to carefully plan, control, monitor and record inmate access to outside telephone lines.

One of the more recent problems with the effectiveness of inmate telephone systems employed to control inmate phone conversations as currently being deployed in prison facilities is that they may be compromised by the use of wireless communications. While electronic micro technology is facilitating a significant reduction in the size of cellular phones, other technologies are increasing their area transmission capabilities in response to increased market demand. With the reduced size, cell phones can be smuggled into prison facilities or be otherwise made available to inmates to transmit and receive information outside the facility in which they are incarcerated and bypass the normal method of controlled communication via the landline inmate telephone control system. It is anticipated that because inmates are aware that conversations over the landline systems are controlled, routinely monitored, and recorded by prison officials, that a transmission taking place over a wireless network would typically involve a conversation that the inmate did not want the prison administration to be aware of, for example, escape attempts/plans, drug or other illicit activity, consumer fraud, victim harassment, etc.

Another problem in penal institutions is the inmates' desire to make threatening or harassing phone calls to witnesses, prosecutors, police officers, parol officers, psychologists, judges, and the relatives and family of such persons. Limiting the inmates' access to land-line telephones, does not effectively address this problem, since it has become easier for an inmate to obtain wireless telephone. Rather, one should, optimally, provide a means that permits a potential call recipient to identify the caller as an inmate before accepting the call, whether that call is placed on a land-line or cellular telephone. Conventionally, this is done by initially placing the inmate on hold and playing a pre-recorded message telling the recipient that a call has been placed from a correctional facility and that, if the recipient wishes not to receive the call, he/she should hang up before the call is connected.

This traditional approach mitigates, but does not fully solve, the harassment problem. In particular, it is still possible for an inmate to repetitively call an outside party; even if the recipient hangs up after hearing the pre-recorded message, the harassing effect of receiving repetitive calls from inside the correctional institution remains. Therefore, it would be highly desirable to provide an institutional telephone system that automatically prohibits inmates from attempting to call certain outside persons, regardless if the call is placed on a land-line telephone or a cellular telephone. Moreover, it would also be highly desirable to provide a method and apparatus for allowing a recipient of an undesired call from an inmate to easily and automatically prohibit all future calls from that particular inmate, or from all inmates generally.

Still another concern in correctional institutions is the regulation of access to telephone systems. For various security and management reasons, it often desirable to restrict a given inmate's telephone access to particular phones, calling times, and to limit the length of calls, number of calls, and number of calls to the same number. Also, to enhance security and discipline, it should be possible to instantaneously revoke an inmate's calling privileges, or to otherwise modify the extent of a particular inmate's calling privileges.

Additionally, correctional institutions typically wish to monitor and/or record certain outgoing calls. It may be desirable that calls to certain numbers are to be monitored live, while others need only be recorded, or that calls be recorded only after a predetermined keyword is spoken. Thus, it is desirable to detect certain keywords spoken during a conversation in order to trigger the recording of a conversation. However, inmate-to-attorney calls cannot legally be monitored or recorded.

Moreover, certain inmates—those who represent particular security risks—deserve live monitoring, as opposed to mere recording. Thus, it would be highly desirable to have a system which automatically initiates the appropriate monitoring and/or recording depending upon the identity of the caller, the identity of the called party, or the words that are spoken.

Because the message content of inmate-to-attorney calls cannot be legally recorded or monitored, such calls can serve as a conduit for the inmate's illegal telephone activity.

Therefore, it would be highly desirable to have a system which could passively—that is, without in any way monitoring or recording what is actually being said—monitor inmate-to-attorney calls to ensure that: (1) the only two people speaking on the line are the inmate and attorney, and/or (2) no DTMF tones, rapid line impedance changes, off-hook conditions or voltage spikes appear on the line, which would indicate that the call was being transferred or that a third party was being added to the call.

The capability to detect signals—such as DTMF tones, rapid line impedance changes, off-hook conditions or voltage spikes—which appear on the line as a telephone call progresses, is extremely important to controlling institutional phone access. Callers, such as inmates in a prison, have the ability to work in concert with others outside of the facility. For example, an inmate may be restricted from calling a particular judge who sentenced him, however, that inmate may call his spouse, who in turn may set up a conference call to the judge, thus allowing the inmate to verbally abuse the judge. Such a conference call may be prohibited by law; however, the correctional facility cannot prevent it, as the called party, in this case, the spouse, has the ability to bridge callers with other outside, unrestricted telephone lines, thus giving the inmate unrestricted telephone access.

The techniques involved in implementing the above-described features, which are required to control correction facility land line telephone access to land lines, are well-known. An integrated institutional phone system was disclosed in Gainsboro U.S. Pat. No. 5,655,013, entitled COMPUTER-BASED METHOD AND APPARATUS FOR CONTROLLING, MONITORING, RECORDING AND REPORTING

TELEPHONE ACCESS. Voice identification was used in Piosenka et al. U.S. Pat. No. 4,993,068, entitled UNFORGEABLE PERSONAL IDENTIFICATION SYSTEM and Hopner et al. U.S. Pat. No. 5,150,357, entitled INTEGRATED COMMUNICATIONS SYSTEM. Techniques for added call detection were disclosed in Gainsboro U.S. patent application Ser. No. 08/726,217, entitled COMPUTER-BASED METHOD AND APPARATUS FOR CONTROLLING, MONITORING, RECORDING AND REPPORTING TELEPHONE ACCESS. A method for detecting certain keywords during a phone conversation, which may be used as triggering events to initiate recording or monitoring, was disclosed in Gainsboro U.S. patent application Ser. No. 08/992,123, entitled AUTOMATIC KEY WORD OR PHRASE SPEECH RECOGNITION FOR THE CORRECTIONS INDUSTRY. These patents and applications are incorporated herein by reference.

However, at the current time, no method or apparatus has been disclosed, which integrates a means to detect, intercept, monitor, record, or limit access of inmates to telephone calls made via wireless communications devices, i.e. cellular mobile radiotelephones (CMR), into an institutional telephone access control system. Only limited application of the detection and recording of CMR calls has been made, such as in the area of police surveillance. See Easterling et al. U.S. Pat. No. 5,428,667, entitled MULTI-CHANNEL CELLULAR COMMUNICATIONS INTERCEPT SYSTEM, issued Jun. 27, 1995. Likewise, wireless communication jamming technology, although applied extensively in the military, has not generally been applied as a means to control cellular telephone access from an institutional facility.

Generally, the technology involved in cellular base stations, including basic call administration and charging, is well established. See, e.g., Meier et al. U.S. Pat. No. 5,612,990, entitled DIGITAL WIRELESS INTERFACE FOR A BASE STATION FOR ESTABLISHING COMMUNICATION BETWEEN A PLURALITY OF DIGITAL RADIO CHANNELS AND A PLURALITY OF DIGITAL WIRELINE CIRCUITS, issued Mar. 18, 1997; Freese et al. U.S. Pat. No. 5,291,543, entitled CELLULAR TELEPHONE REAL-TIME ACCOUNT ADMINISTRATION SYSTEM, issued Mar. 1, 1994; and Comer U.S. Pat. No. 5,610,973, entitled INTERACTIVE ROAMER CONTACT SYSTEM FOR CELLULAR MOBILE RADIOTELEPHONE NETWORK, issued Mar. 11, 1997. However, this cellular technology, as in the case of the interception and jamming of cellular calls mentioned above, has not yet been applied to overcome the above-discussed problems involved in institutional telephone access control.

### SUMMARY OF THE INVENTION

In light of the above, one object of the invention is a method of managing wireless telephone activity in an institutional environment to achieve improved security and call control. Another object of the invention is a system adapted to perform such institutional wireless telephone management.

Yet another object of the invention is a method and apparatus for passively monitoring and/or recording a wireless telephone connection to detect security breaches without violating any laws protecting the privacy of a caller.

A further object of the invention is an institutional wireless telephone management system wherein the parameters that control the operation of the system as well as the records of system activity are stored in a central database, thereby permitting simple customization of system operation, generation of reports and monitoring of status.

In accordance with one aspect of the invention, a method of managing telephone activity in an institution includes the steps of: (1) intercepting a wireless transmission from a caller (the “calling party”) attempting to place a cellular call; (2) identifying the location of the caller to ensure that the caller is within the institution; (3) where the call originated from within the controlled institution, processing the wireless transmission signal to validate its transmission by (a) acquiring the signal's identifying data (i.e. NPA/NXX/XXXX, ESN, number called, caller's voice, called party's voice, etc.), (b) comparing the signal's identifying data with a preauthorized list of “allowed” identifying data, and (c) after said comparison, either (i) reporting the unauthorized transmission and location to the appropriate administrator, or (ii) discontinuing the analysis of the authorized transmission; (4) determining, in response to said comparison, whether to permit said connection of the institutional caller to the outside recipient, and optionally, whether to indicate any of a plurality of messages to the calling party, e.g., “an inmate is calling you,” etc.; (5) optionally providing call administration services, consisting of monitoring and recording data regarding the call and accounting for local and airtime charges; (6) optionally providing real-time call monitoring or recording, as manually instructed or automatically as preprogrammed by the administrator; (7) optionally terminating the transmission or otherwise tracking or accounting for calls to third parties whereby attempts are made by the called party to bridge or conference the calling party (the caller or inmate) with any third party; and (8) optionally preventing the communication via wireless jamming techniques or other means.

In accordance with another aspect of the invention, an apparatus for managing wireless telephone activity in an institution includes: one or more receptor antennae selectively positioned near or around the institution for the interception of wireless transmissions into or out of the institution; one or more transmission antennae for the establishment of a cellular transmission with the CMR, for the jamming of a communication between the CMR and a local cell site, or for the mediation of communication between the CMR and a local cell site; a tunable receiving/scanning device for receiving wireless signals intercepted by said receptors; a computer control unit (CCU), coupled to the receiving/scanning device, for controlling the interception and detection of the wireless signals, interpreting the intercepted signals, and comparing the identifying data with a preauthorized database to determine whether the call is authorized or not; a monitoring and recording device; and an optional wireless transmitter. The database associated with the CCU contains information regarding authorized wireless transmitting devices within the institution and/or information containing the voice verification patterns of persons within the institution, some of whom are granted wireless communication access.

In a preferred embodiment, prior to connecting a call, the system may play an announcement to the called party, identifying the institution and caller and describing the options available to the called party. In response, the called party may enter the preferred DTMF tone sequence. The DTMF sequence could indicate to the system that the called party desired to receive the call in question, future calls from the specific caller, and/or future calls from other similarly situated prospective callers. Alternatively, the DTMF sequence would indicate that the called party desired to reject the call in question and future calls. The system would then effect the modification of a record in the database, in order to save the called party's response for future reference.

In addition, other features of the wireless communications control system provide various security and monitoring functions. For example, the invention provides three levels of monitoring, any or all of which may be active for a given call. The first level is “live” call (voice) monitoring, where the prison officials may actively listen to a live call. The second level is call recording. The system can be programmed to enable associated recording equipment to record telephone calls for later monitoring. The third level is “passive” line monitoring, where the system detects, for example, multiple NPA/NXX/XXXX signals, DTMF tones, off-hook conditions, voltage spikes and/or sudden line impedance changes, in order to track attempts at unauthorized three-way calling, call conferencing, call transferring, call forwarding or re-dialing via various alternate common carriers, many of whom now offer “1-800” or local telephone number (e.g., “950”) access numbers.

In accordance with the preferred embodiment of the invention, all calls are passively monitored and all calls that can be legally recorded—i.e., all but inmate-to-attorney calls—are recorded. At any time, prison officials can selectively invoke live monitoring to listen in on any call in progress, except an inmate-to-attorney call. System alarms, which trigger any time a particular inmate places a call or calls a certain person, allow officials to determine when live call monitoring is appropriate. Likewise, the telephone system of the present invention can be programmed to default in any manner. For example, the system can be set to connect only those telephone calls that are among a pre-approved list of telephone numbers. Conversely, the system can be set to connect all telephone calls except those that are among a list of restricted telephone numbers.

In addition, the invention may include biometric voice verification features. The system, for example, may digitize a sample of the caller's voice. The system then compares the digitized sample with a stored voice print, to verify the identity of the caller. Also, such biometric monitoring may be used to automatically determine the authorized/unauthorized status of the caller. This could be achieved by comparing the live or recording biometric sample with a pre-approved list/database of voices for the particular wireless signal intercepted. Such biometric monitoring may also be used in a passive call monitoring mode, wherein the system takes periodic samples of the parties' voices and checks against a database of voice prints, in order to capture and monitor records of unauthorized callers who may be participating in a call, either via phone sharing or via third party calling.

The principal feature of the present invention is the implementation of a way to detect, monitor, record and control inmate or other regulated caller wireless telephone calls or other wireless transmissions to outside parties; to prevent unauthorized receipt by inmates of wireless telephone calls or other wireless transmissions; and to detect, trace, and prevent unauthorized wireless telephone calls whereby said called parties act to bridge the inmate or regulated caller to some third party.

Broadly, the present invention takes the form of an apparatus and method for intercepting the transmission of wireless communication signals in order to provide wireless communications control and management in an institutional environment.

### BRIEF DESCRIPTION OF THE DRAWINGS

A further understanding of the present invention can be obtained by reference to the preferred embodiments set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows an overall view of a simple preferred embodiment of the present invention comprising the major components of an apparatus according to the present invention, including a plurality of reception antennae, a scanner/receiver, an optional monitor/record station, and a microprocessor-based control unit (Enforcer), which optionally may be integrated with a personal computer in order to provide a simple graphical interface;

FIG. 2 shows a conventional inmate call control system and how the use of wireless transmission (e.g., cellular telephones) can circumvent the conventional inmate call control system;

FIG. 3 shows a symbolic representation of the operation of a simple preferred embodiment of the present invention whereby a wireless transmission is detected, intercepted, referenced for authorization, and either approved or reported to an administrator;

FIG. 4 shows a conventional apparatus for intercepting a cellular transmission;

FIG. 5 is a flow diagram depicting the operation of applicant's unauthorized cellular transmission call detection system;

FIG. 6 is a block diagram of the operation of applicant's unauthorized cellular transmission call detection system; and

FIG. 7 is a block diagram of an alternate, more complex preferred embodiment of the present invention, whereby a transmit antenna and telecommunications switching hardware enables the system to act as a base station or intermediary between the cellular phone and the cell site in establishing incoming and outgoing calls to the cellular phone.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The preferred embodiment(s) will be described with reference to prison based wireless call management and security. This, however, should not be viewed as limiting, since the invention is also applicable in other institutional settings such as military bases, schools, mental institutions and business organizations. Likewise, the invention is applicable to the interception of a wide variety of wireless transmissions, such as amateur (ham) radio or cb radio signals.

Upon detection of a wireless transmission, in accordance with the present invention, the system first determines whether the transmission is an allowed transmission originating from within the facility by prison officials by comparing the NPA/NXX/ESN or other identifying data against a listing of all approved NPA/NXX/ESNs (or respective data) within the institution. If there is a direct correlation, indicating that the transmission is originating from an approved device or made by an authorized prison official, the system will determine that the transmission is an allowed transmission and discontinue further monitoring activity at that point. However, if the call is not on the approved equipment list, then the system will proceed to process the alert. In this way, the system can identify calls made, for example, from a phone stolen from a prison guard.

The system will then compare the destination phone number to a list of allowed destination phone numbers. This function may optionally be performed via an interface to an existing prison land-line call control system. The results of the comparison will be displayed on a small LCD screen on the microprocessor-based control unit, or sent to the optional investigative terminal, for notification and/or analysis. In a preferred embodiment, the method and apparatus will detect and perform the above operations in a real-time mode so that investigative personnel will have the opportunity to take action on the call as it is occurring. Further, the method and apparatus will enable real-time monitoring and recording via an output to a monitoring/recording station. In addition to the real-time detection capabilities, the preferred method and apparatus will enable a full range of reports detailing call detail characteristics and other detectable parameters which can serve as data comparison with other available investigative databases. Optionally, the preferred method and apparatus will enable jamming of the unauthorized transmission.

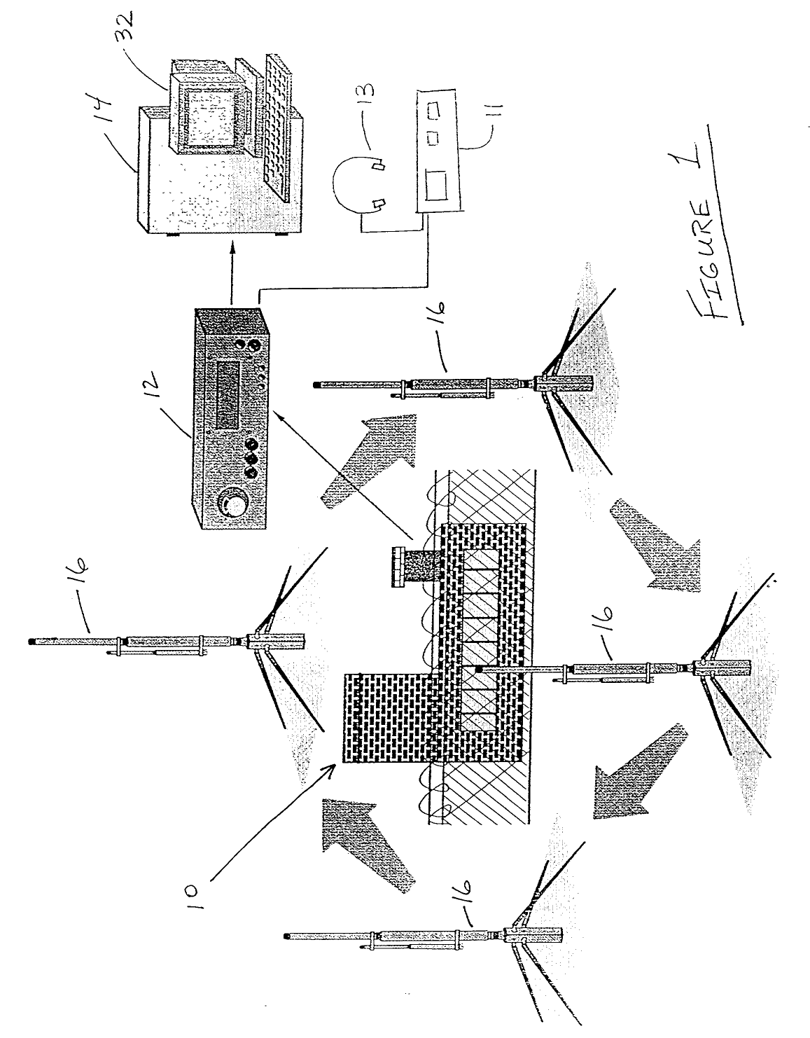

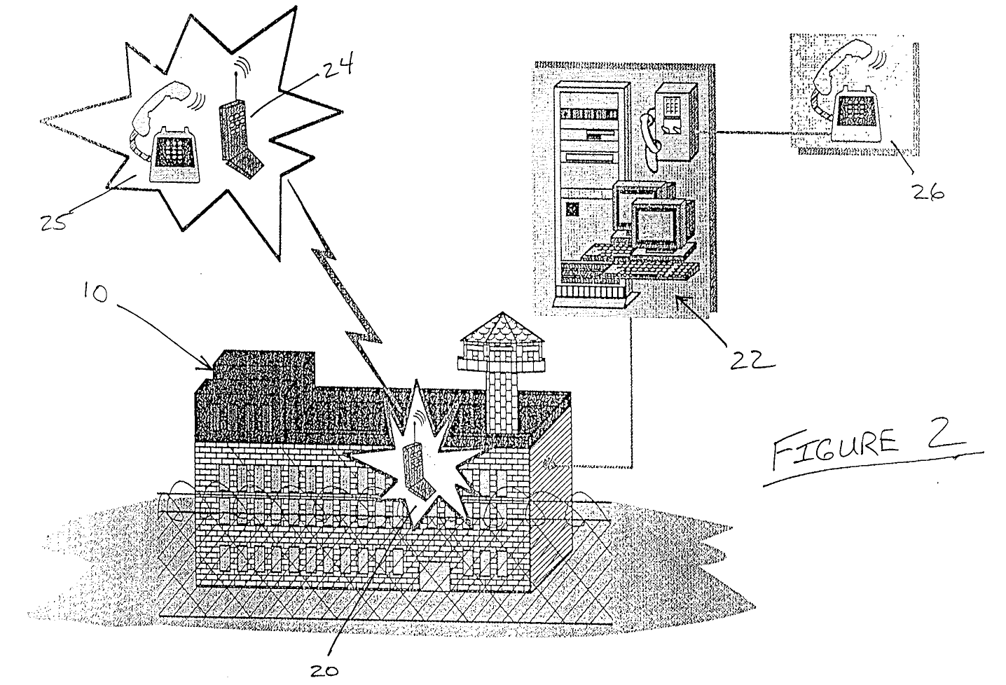

FIG. 1 represents a simple embodiment of the above, incorporating reception, interpretation, monitoring, recording, and controlling wireless signals. In FIG. 1, a wireless communications management system according to the present invention detects wireless transmissions to or from any of a plurality of wireless telephones within an institution 10. As shown, a preferred apparatus of the present invention comprises a microprocessor-based control unit 14 (MCU)(or ENFORCER), a scanner/receiver 12, and at least one reception antennae 16. Optionally, the system of this invention can be integrated with an existing institution call control system 22 (see FIG. 2) to provide a fully integrated call management system within an institution 10.

In operation of the preferred embodiment of the present invention, when a cellular mobile radiotelephone originates a call, it transmits a series of data messages to the local base station. These messages, referred to as a Call Origination, are defined by EIA/TIA-533. These data messages always contain (1) the low order seven digits of the unit's telephone number, known as the Mobile Identification Number (MIN); (2) the unit's Station Class Mark (SCM), which identifies functional characteristics of the unit; and (3) the Called Address, or dialed telephone number. The MIN2 (the high order three digits or NPA of the cellular unit's telephone number), and the Electronic Serial Number (ESN) are typically also transmitted.

When this wireless transmission is made in the vicinity of the institution, the transmitted signal is received by reception antennae 16 and routed to the scanner/receiver 12, where the transmitting frequency is identified and isolated, and the signal demodulated. The scanner/receiver 12 identifies the signal's NPA/NXX/ESN or other identifying data and passes the data to the MCU 15; alternatively, the MCU 15 can itself identify the signal's identifying data based upon the received signal. The MCU 15 then compares the data against a list of preauthorized wireless transmission signals. If the signal's NPA/NXX/ESN is found to be authorized, no further action is taken and the call is permitted to continue without further monitoring. If, on the other hand, the signal is unauthorized, the MCU 14 may jam the transmission, notify an administrator of the unauthorized transmission, etc., and the call may be monitored and recorded via the monitor/record station 13

A preferred apparatus of this invention interfaces MCU 14, scanner/receiver 12, one or more administrative terminals 32, and reception antennae 16. If the system components are collocated, a data/communications/control bus would serve to interconnect them. Otherwise, a LAN/WAN network, perhaps including dedicated digital data/telephone line services, could be used. The preferred structure would accommodate data transfers, digitized voice signals, call processing data, and the like. In addition to the real-time detection capabilities, the apparatus will enable a full range of reports detailing call detail characteristics and other detectable parameters which can serve as data comparison with other available investigative databases.

Optionally, scanner/receiver 12 can provide digitized voice samples in order to record messages (such as the inmate's name) and to support biometric voice verification or monitoring functions. Scanner/receiver 12 (or other comparable apparatus) could be configured to provide digitized voice samples, for example, for each call made, whereby such samples are sufficient in length to provide verification that the inmate indeed participated in a conversation with a particular called party on a particular date and at a particular time and on a particular cellular telephone. Thus, if an inmate or a called party subsequently claims that a particular telephone communication never occurred, the prison administrator can retrieve the voice verification record to evaluate whether claims that certain calls were never made are in fact false.

Referring now to FIG. 2, shown is a conventional inmate call control system whose effectiveness is compromised by the use of wireless communications. While electronic microtechnology is facilitating a significant reduction in the size of cellular phones, other technologies are increasing their area transmission capabilities in response to increased market demand. With the reduced size, cell phones can be smuggled into prison facilities or be otherwise made available to inmates to transmit and receive information outside the facility in which they are incarcerated and bypass the normal method of controlled communication via the land line inmate telephone control system. More specifically, should an inmate obtain an unauthorized cellular telephone 20 inside the institution 10 and attempt to place a call to an outside party 24 or 25, this type of transmission circumvents the standard inmate call control system 22 which will control only calls placed on land line telephones within the call control network placed to a call controlled party 26.

MCU 14 is ideally an 80586-based personal computer configured to operate under a suitable operating system. A database management system (DBMS) or relational database management system (RDBMS), which includes a structured query language (SQL) interface, is used to store system configuration and status information. An SQL forms-generator provides access to the stored configuration and status information. An SQL menu program allows users to easily navigate the database system. An SQL report writer is used to generate reports of calling activity or other system usage. Interface software in MCU 14 is configured to manage communication between MCU 14 and scanner/receiver 12. Real-time control software manages the real-time activity of the system. Alternatively, if features requiring sophisticated signal processing are sacrificed, the MCU could be implemented on a slower microprocessor, so long as the necessary data inputs, data comparisons, alarm outputs, and report generation features are provided.

Additionally, from an administrator/user perspective, the MCU software can support the following general functions:

(1) establishment and configuration of individual inmate data;

(2) checking of authorization status of wireless equipment;

(3) setting of global (i.e. institution wide) and individual restrictions on telephone access;

(4) real-time monitoring of inmate telephone calls and alerts, along with the ability to cut off inmate calls individually or globally;

(5) storing and reporting of telephone usage data; and

(5) digitally storing conversations for future reference, upon manual instruction from the administrator or automatically upon the triggering of certain events, such as the speaking of certain keywords.

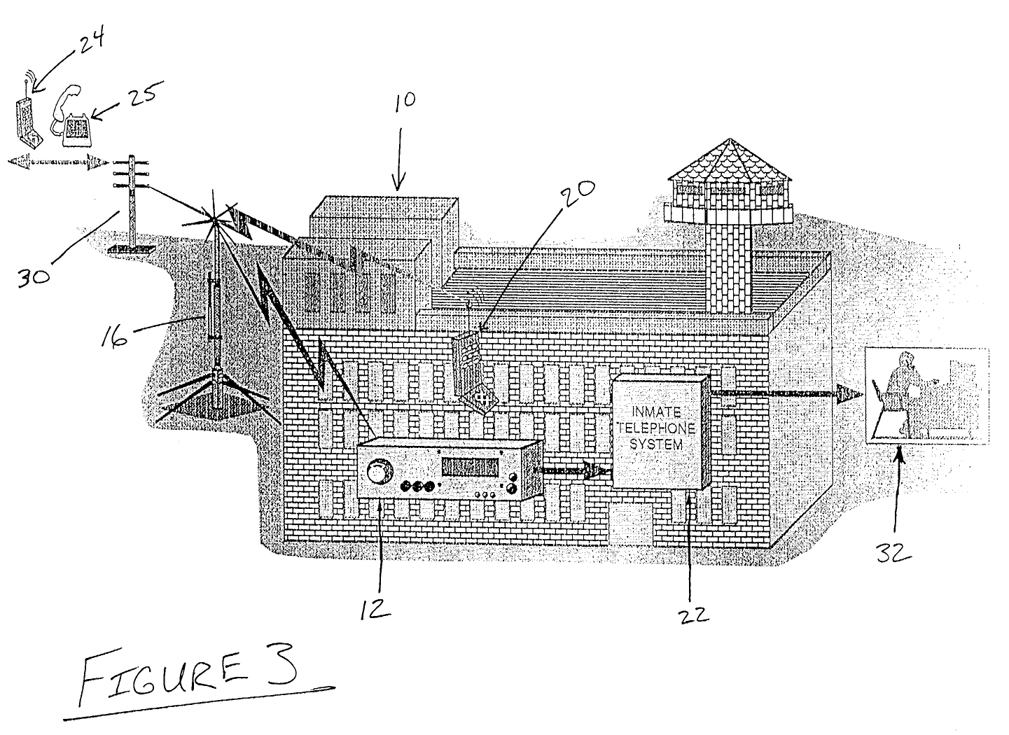

Referring now to FIG. 3, a simple exemplary operation of the system of the present invention is shown. When an inmate obtains an unauthorized wireless telephone 20 within an institution 10 and attempts to make a wireless transmission to an outside party 24 or 25, the signal will reach a standard cell site 30, as usual. In accordance with this invention, the wireless signal is also detected and received by receptor antennae 16 (one or more may be used) positioned in close proximity to institution 10, and which are connected to scanner/receiver 12.

The intercepted signal information is then passed to MCU 14 where it is compared to a list of preauthorized wireless transmission signals. MCU 14 then takes the appropriate action based on its preprogrammed list of responses, including but not limited to disconnecting the transmission (via jamming or via an arrangement with the local cellular provider), notifying an administrator, or recording the transmission.

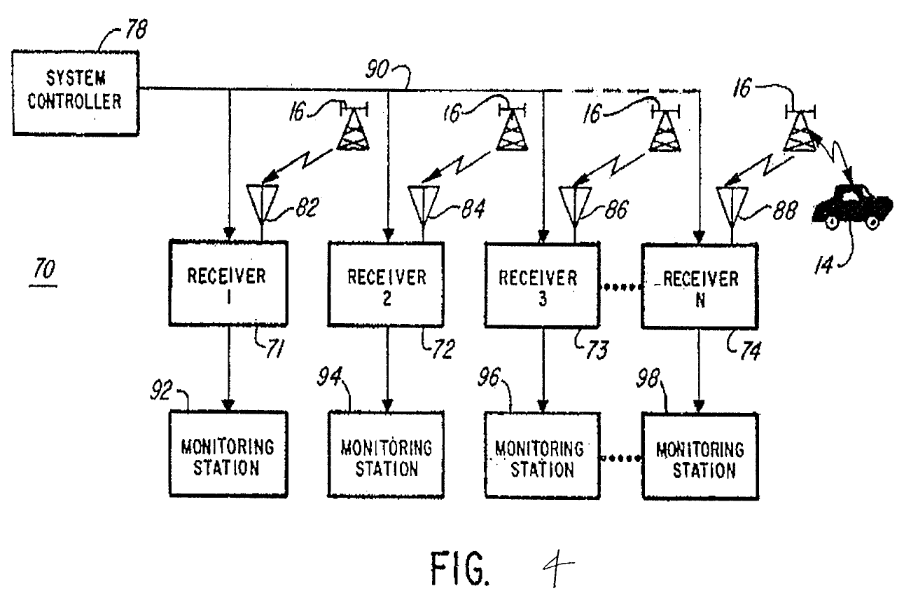

A conventional method and apparatus for the intercepting and recording described above were disclosed by Easterling et al. See FIG. 4. The disclosed system includes antennae 82,84,86,88, tunable receivers 71,72,73,74, computer-based controller 78, and monitoring stations 92,94,96,98. Some of the receivers 71,72,73,74 are tuned to the local control frequencies (or channels) used by the cellular base stations covering a given area. When a cellular phone registers at the base station, the monitoring system acquires that phone's MIN, ESN, and other information. The base station's control frequencies are then monitored to detect instructions from the base station to that cellular phone, assigning one of the many available voice channels for that phone's use in connecting to a land line. One of the monitoring system's tunable receivers is then retuned to that voice channel assigned for the call, so that the conversation can be monitored or recorded.

One of the problems involved in applying the method of Easterling et al. to a penal institution is that cellular calls originating outside the facility should not be monitored or recorded by institutional equipment. This difficulty is overcome in the present invention by the use of either directional antennae or triangulation circuitry, in order to establish that the cellular phone involved is actually within the institution premises. Triangulation information could also be displayed on an administration terminal or otherwise used to locate the unauthorized phone within the institution premises. For a discussion of some of the methods of triangulation which can feasibly be incorporated into this invention, see Maloney et al. U.S. Pat. No. 4,728,959, entitled DIRECTION FINDING LOCALIZATION SYSTEM (applying phase angle measurements as a means to locate wireless transmission sources); Stilp et al. U.S. Pat. No. 5,327,144, entitled CELLULAR TELEPHONE LOCATION SYSTEM (applying time of arrival measurements); and Marinelli et al. U.S. Pat. No. 4,884,208, entitled SYSTEM FOR CONTINUOUSLY ESTABLISHING AND INDICATING THE LOCATION OF A MOVEABLE OBJECT (applying signal strength measurements).

Another difficulty which arises in the application of the method and apparatus of Easterling et al. to the current institutional environment is that the disclosed method does not take into account the recent rapid progress made in digital and PCS telephone systems using advanced signaling schemes. Although the wireless communication data may normally be acquired even from TDMA digital transmissions, CDMA transmissions can be demodulated and unencrypted only if additional call parameters are made available through the cellular phone network. Therefore, the present invention overcomes this difficulty through an interface with the cellular network and/or by coordinating unencryption with the local cellular service providers.

In an alternative embodiment of the present invention, the MCU 14 is also responsible for detecting attempts by the called party to connect the calling party to a third party. Such attempts may, for example, be detected by listening for additional DTMF or dial tones. The MCU 14 would then take appropriate action, such as jamming or otherwise disconnecting a call to a caller upon sensing a dial tone. The MCU 14 may also record both (1) the number the called party attempted to connect the inmate to and (2) the number of the called party (of course). The MCU 14 may keep track of call history on a per inmate, per caller, per called party basis, and the like. The MCU 14 may also compare the third party call to a list of authorized calls and alert the institution authorities if an attempted third party call is not authorized.

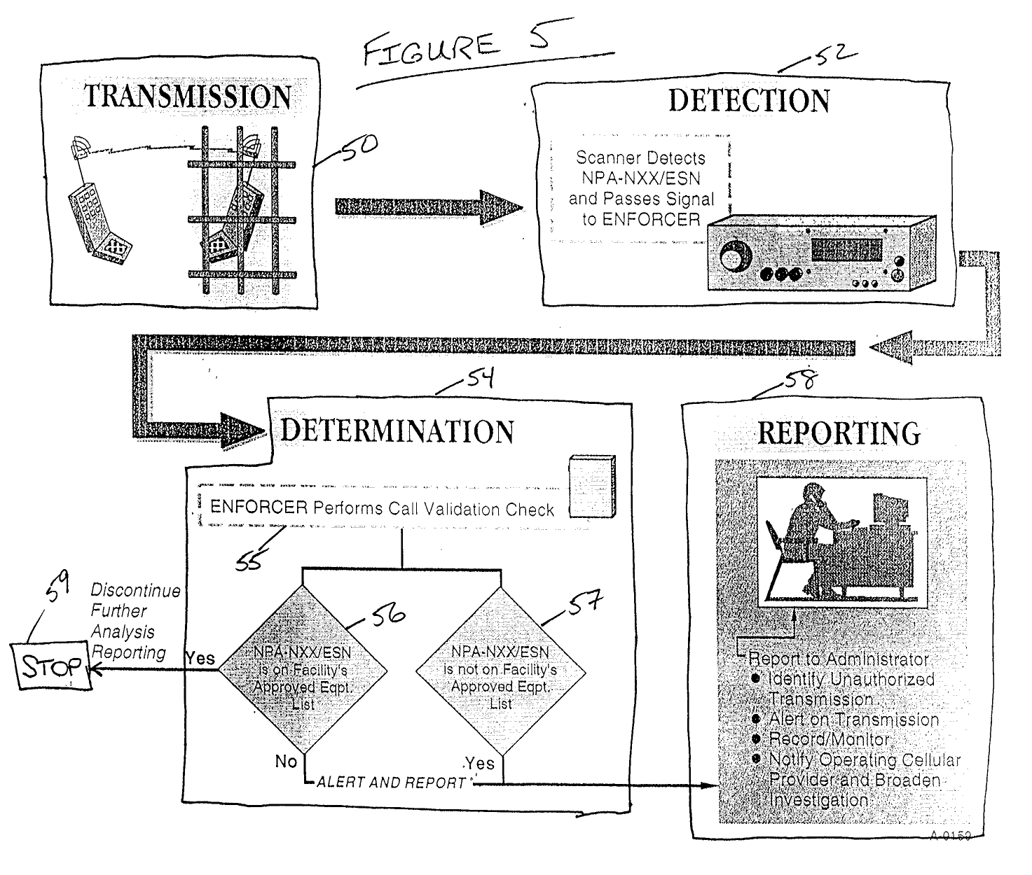

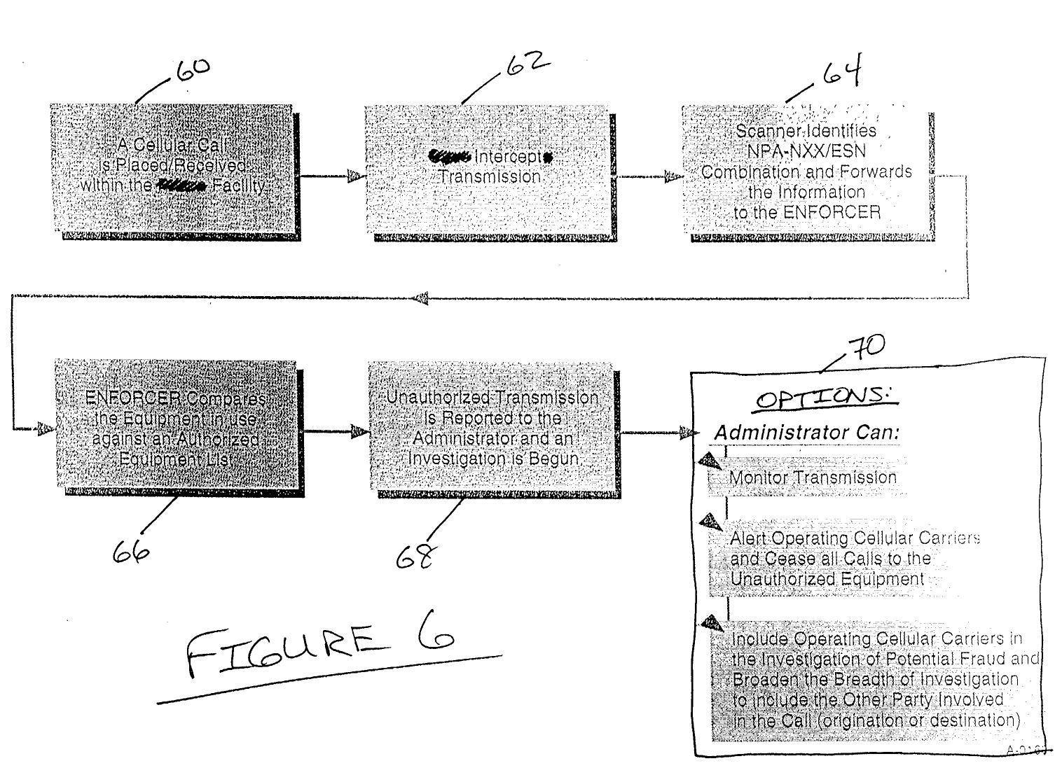

Turning finally to FIGS. 5 and 6, shown are flow diagrams depicting the preferred operation of applicant's wireless communication management system as described above. To reiterate the operation of the present invention, the system operates when an attempted wireless transmission 50/60 into or out of a controlled institution occurs. At this point, the identifying data associated with the wireless transmission is detected 62 and identified 64 by scanner/receiver device 52 using reception antennae 16 positioned around the institution being monitored. The signal is then passed along (52/64) to MCU 14 where a call validation check 55 is performed (66), thereby determining whether the transmission was authorized or unauthorized. Preferably, this is done by comparing the intercepted NPA/NXX/ESN signal with a pre-approved list stored in MCU 14. If the intercepted NPA/NXX/ESN signal is approved 56, then the system discontinues any further investigation into the transmission 59. On the other hand, if the intercepted NPA/NXX/ESN is not on the approved list 57, then the system continues the investigative operation, including but not limited to: (1) recording the transmission, (2) reporting the transmission to an administrator, (3) identifying the parties via voice recognition and comparison software, (4) notifying the operating cellular provider and broaden the investigative efforts, (5) monitoring the live transmission to ascertain the nature of the transmission (58/70).

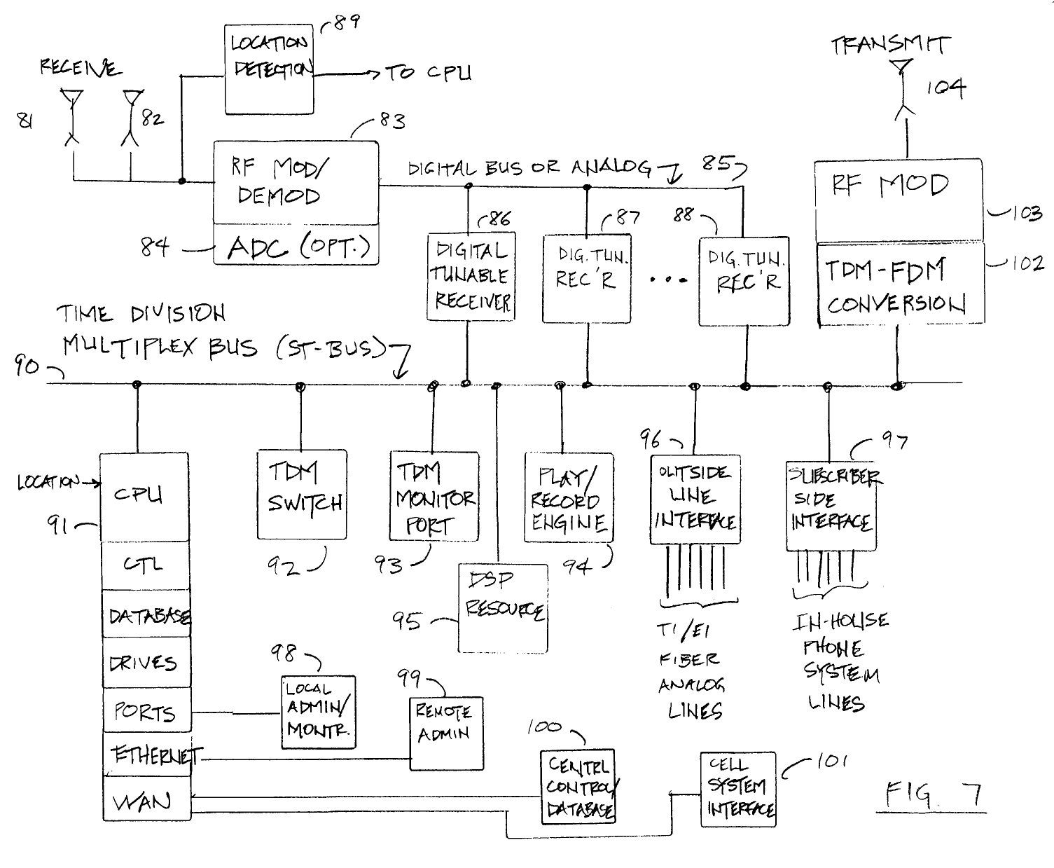

A more detailed block diagram of the preferred embodiment of the invention, including the more complex optional features, is shown in FIG. 7. In order to provide a higher level of call control, an additional transmitting antenna 105 is added. The institutional wireless communication management system would then act as an intermediary between the local cell site and the unauthorized cellular phone. Because a cellular phone automatically locks on to the strongest nearby control signal, the wireless communications management system may act as a full-fledged cell site, base station, and/or MTSO, to capture and process cellular calls placed from within the prison facility. In this way, the wireless communications management system could play an active role in establishing (or disconnecting) a cellular phone call. Complete call control may then be exercised over all detected calls. This embodiment would include voice messaging or voice synthesis equipment, to facilitate features such as over-the-phone voice prompting or any voice activated, responsive or interactive telephone feature. For example, when an unauthorized wireless transmission is identified, the system might broadcast a voice message to either the calling or the called party, instead of, or in conjunction with notifying an administrator, or prior to disconnecting the transmission, to inform the parties of the unauthorized nature of the transmission along with the actions being taken. Additionally, the institution would then be able to charge for local land line usage, at costs commensurate with other institution land line charges.

With reference to FIG. 7, when a cellular phone powers up or enters the prison region, the cellular phone registers with the institutional base station on the normal control channel. The signal is received via antennae 81,82 and demodulated via rf demodulator 83, as is customary for a cellular communication scheme. The resulting baseband signal could be optionally converted to a digital form via an analog-to-digital converter 84. The signal is then passed to the system via a suitable digital bus or analog line 85. Multiple digital tuners 86,87,88 are used in parallel to isolate and digitize the various communications channels, and the signals are placed onto a time division multiplexed bus 90 such as the Mitel Serial Telecom Bus (ST-BUS). Processing, memory, storage, LAN/WAN, local ports, and control functions are implemented via computer control unit (CCU) 91. The CCU 91 provides interfaces to the local administrative and monitoring terminals 98, remote administrative and monitoring terminals 99, central database 100 (located, perhaps, at an institutional headquarters), and local cellular system 101. Outside lines (T1/E1, fiber optic, analog, etc.) are interfaced to the ST-BUS via outside line interface module 96, and local institutional phones are likewise incorporated into the system via a subscriber side interface module 97. Any of these lines may be interconnected via a TDM switch 92. Voice messaging and voice synthesis are accomplished via play/record engine module 94, and advanced speech recognition and line signal processing may be implemented via one or more DSP resources 95, which are interfaced to the ST-BUS in such a way as to permit them to connect to any time slot or stream. Signals are transmitted via an TDM to FDM (frequency division multiplexed) signal converter 102, an rf modulator 103, and a transmit antenna 104. TDM to FDM conversion is well known in the art and will not be further described herein.

Because the system is only intended to intercept calls made from within the institution, location detection module 80, operating on the basis of direction-limited receiving antennas or triangulation via signal strength, time of signal arrival, or angle of signal arrival, may also be incorporated. It is important to note that no jamming transmission equipment is necessary with this embodiment, because the system may block a transmission simply by not completing a call.

One who is skilled in the art will recognize the many features which are made available by a system architecture such as this. Any feature involving voice synthesis or voice response may be implemented, including customized voicemail, collect call processing, call completion, etc. The CCU 91 may provide complete call administration, record keeping, and billing, and interface therein either with remote systems or with a local land line call control system such as that described in Gainsboro U.S. Pat. No. 5,655,013. The database feature allows call control (i.e. completion, disconnection, introduction, etc) according to predetermined parameters. The digital signal processors, integrated within each line interface and subscriber interface card, as well as available on the DSP resource, permit calls to be monitored for PBX signals, DTMF tones, etc, as well as voice recognition and keyword triggering. Any call may be recorded automatically in digital or analog format.

The open architecture permitted by the ST-BUS enables the addition of specialty modules as required for future interface or processing needs; the system could easily be used to detect and control other forms of wireless communication such as amateur (ham) radio, cb radio, or “walkie-talkie” signals, as long as the appropriate demodulation hardware was included in the system.

While the invention has been described with reference to one or more preferred embodiments, such embodiments are merely exemplary and are not intended to be limiting or represent an exhaustive enumeration of all aspects of the invention. The scope of the invention shall be defined solely by the following claims.

What is claimed is:

1. A method of controlling wireless communication activity in an institution, wherein said method comprises the steps of:
(1) detecting and receiving wireless communication signals;
(2) conveying said wireless communication signals to a processing means;
(3) identifying the location of the wireless transmitting device;
(4) comparing said wireless communication signals with a set of predetermined signals, wherein said comparing determines whether said wireless communication is “authorized” or “unauthorized”; and
(5) providing an appropriate “alert” output for unauthorized transmissions.

2. A method of controlling wireless communication activity in an institution according to claim 1, wherein said wireless communication signals are ESN signals.

3. A method of controlling wireless communication activity in an institution according to claim 1, wherein said wireless communication signals are MIN signals.

4. A method of controlling wireless communication activity in an institution according to claim 1, wherein said wireless communication signals are voice signals.

5. A method of controlling wireless communication activity in an institution according to claim 1, wherein said attempts are recognized and reported.

6. A method of controlling wireless communication activity in an institution according to claim 1, wherein said signals are monitored and/or recorded.

7. A method of controlling wireless communication activity in an institution according to claim 1, wherein said method additionally includes terminating the wireless communication;

7. A method of controlling wireless communication activity in an institution according to claim 1, wherein said method additionally includes preventing the wireless communication;

9. A method of controlling wireless communication activity in an institution according to claim 1, wherein said method additionally includes connecting the wireless communication to a land telephone line.

10. An apparatus for controlling wireless communication activity in an institution, wherein said apparatus comprises:
(1) a wireless communication connection attempt by a caller to a called party, one of whom is located within the institution, wherein said attempt includes the wireless transmission of a pre-defined scheme of signals;
(2) one or more reception antennae for intercepting said communication connection;
(3) a scanning/receiving device activated by said reception antennae for receiving and isolating said scheme of signals; and
(4) a comparator/control unit for comparing said signals with a set of predetermined signals to determine whether the connection of said institutional caller and said outside recipient is authorized or unauthorized.

11. An apparatus for controlling wireless communication activity in an institution according to claim 10, wherein said wireless communication connection is interrupted in response to the intercepting of said set of signals.

12. An apparatus for controlling wireless communication activity in an institution according to claim 11, wherein said wireless communication connection is interrupted via jamming.

13. An apparatus for controlling wireless communication activity in an institution according to claim 11, wherein said wireless communication connection is interrupted via a communication to a local wireless services provider.

14. An apparatus for controlling wireless communication activity in an institution according to claim 10, wherein said attempts are recognized and reported.

15. An apparatus for controlling wireless communication activity in an institution according to claim 10, wherein said attempts are monitored and/or recorded.

16. An apparatus for controlling wireless communication activity in an institution according to claim 10, wherein said scheme of signals includes ESN signals.

17. An apparatus for controlling wireless communication activity in an institution according to claim 10, wherein said scheme of signals includes MIN signals.

18. An apparatus for controlling wireless communication activity in an institution according to claim 10, wherein said scheme of signals includes voice signals.

19. An apparatus for controlling wireless communication activity in an institution according to claim 10, wherein said apparatus additionally includes a wireless base station capable of establishing communication between a plurality of wireless mobile units and a plurality of land line circuits, located within or near the institutional facility.
